(19) United States
(12) Patent Application Publication
(10) Pub. No.: US 2015/0084880 A1
(43) Pub. Date: Mar. 26, 2015

(54) FUNCTIONAL FINGERTIP SLEEVE

(71) Applicant: Chiun Mai Communication Systems, Inc., New Taipei (TW)

(72) Inventors: HOW-WEN CHIEN, New Taipei (TW); CHE-HSIN CHAO, New Taipei (TW); BO-HAN CHU, New Taipei (TW); KUI-HAO CHANG, New Taipei (TW)

(73) Assignee: CHIUN MAI COMMUNICATION SYSTEMS, INC., New Taipei (TW)

(21) Appl. No.: 14/163,767

(22) Filed: Jan. 24, 2014

(30) Foreign Application Priority Data
Sep. 24, 2013 (CN) 2013104360923

(51) Int. Cl. G06F 3/041; G06F 3/16

(52) U.S. Cl. CPC G06F 3/041; G06F 3/16; G06F 2203/04107
USPC 345/173

(57) ABSTRACT

A fingertip sleeve used for touching a screen includes a sleeve, a canner, a microprocessor and a speaker. The touch region can be configured to touch the screen. The scanner can be configured to scan information displayed on the screen and convert the displayed information into digital signals. The microprocessor can be electronically connected to the scanner and converting the digital signals into audio signals. The speaker can be electronically connected to the microprocessor and outputting audio based on the audio signals.

### BACKGROUND

1. Field

The disclosure generally relates to fingertip sleeves, and particularly to a fingertip sleeve which is capable of outputting an audio signal of information displayed on a screen.

2. Background

Digital devices using touch screens such as computers and mobile phones are becoming increasingly popular. The touch screens can be manually operated by a finger of a user. However, oil from the skin of the finger may leave a greasy print on the touch panel screen. Therefore, a fingertip sleeve can be used to touch the panel screen. However, the fingertip sleeve merely has a single function as a stylus used to touch the screen.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the disclosure.

FIG. 1 is a schematic view of a functional fingertip sleeve, according to an exemplary embodiment of the disclosure.

FIG. 2 is a schematic view of the fingertip sleeve of FIG. 1 put on a finger to touch a screen.

FIG. 3 is a block diagram of the fingertip sleeve of FIG. 1.

### DETAILED DESCRIPTION

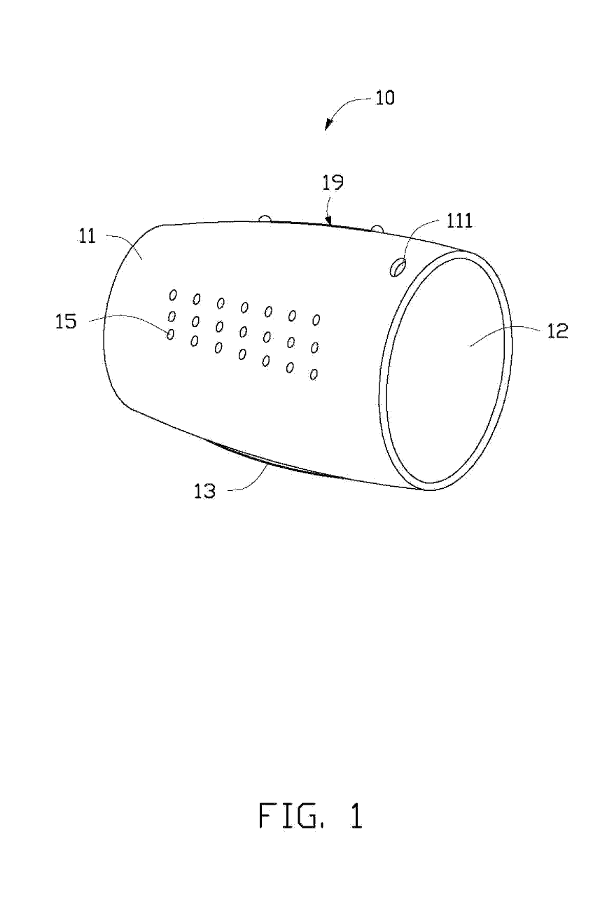

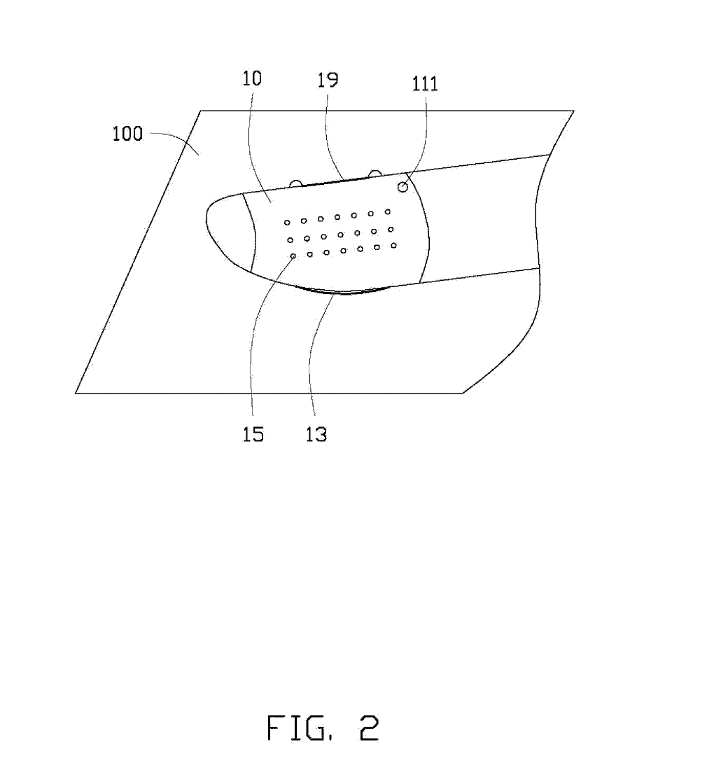

FIG. 1 is a schematic view of a functional fingertip sleeve 10, according to an exemplary embodiment of the disclosure. The fingertip sleeve 10 is used to operate a touch screen 100 (shown in FIG. 2) and output an audio (e.g. playing a voice) of information displayed (such as characters) on the screen 100. FIGS. 1-3 illustrate that the fingertip sleeve 10 can include a sleeve 11, a touch region 13, a speaker 15, a scanner 19, and a data processing unit 21.

The sleeve 11 is made of elastic material and defines an opening 12. The opening 12 is used for sleeving the sleeve 11 on a finger of a user. A through hole 111 is defined in the sleeve 10 adjacent to the opening 12. The hole 111 is configured to hang a decoration such as a necklace or bracelet, so that the sleeve 11 can be conveniently carried. In addition, the sleeve 10 can be colored to serve as a decoration for an electronic device such as a mobile phone.

The touch region 13 is positioned on an outer surface of the sleeve 10 and protrudes from the sleeve 10 so that the touch screen 100 can be accurately touched. The touch region 13 may be made of flexible conductive material such as conductive rubber and fabric.

The scanner 19, the data processing unit 21, and the speaker 15 are positioned in the sleeve 11 and are electronically connected in series. The scanner 19 scans information displayed on the screen 100 and converts the displayed information into corresponding digital signals. The data processing unit 21 obtains the digital signals and converts the digital signals into corresponding audio signals. The speaker 15 outputs the audio signals from the data processing unit 21 for the user. In this embodiment, the scanner 19 and the touch region 13 are opposite to each other.

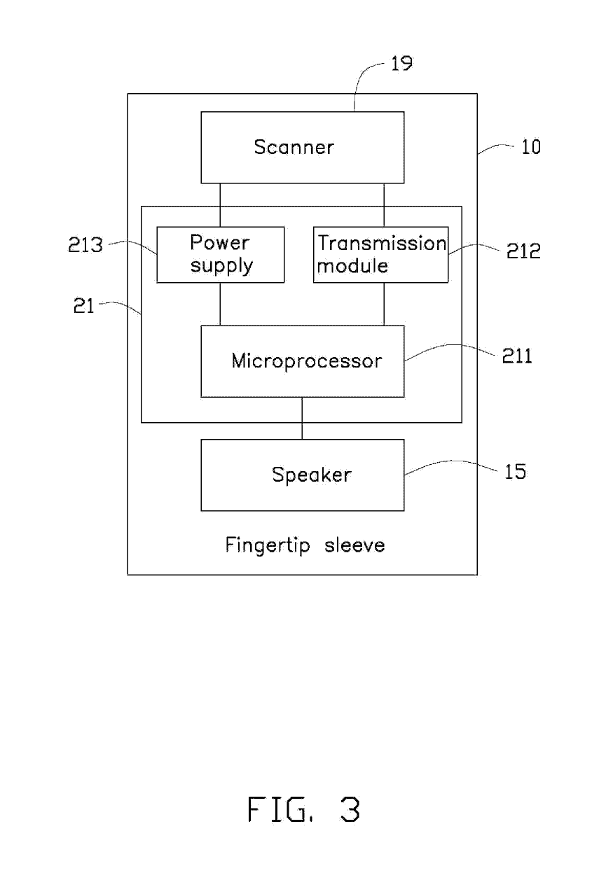

Referring to FIG. 3, the data processing unit 21 includes a microprocessor 211, a transmission module 212, and a power supply 213. The microprocessor 211 is electronically connected to the scanner 19 via the transmission module 212 and is directly connected to the speaker 15. The microprocessor 211 obtains the digital signal from the scanner 19 via the transmission module 212 and converts the digital signal into the corresponding audio signal. The power supply 213 is electronically connected to the scanner 19 and the microprocessor 211 to provide electric power to the scanner 19 and the microprocessor 211.

In use, the sleeve 10 is positioned over the finger of the user through the opening 12. Contact with the touch screen 100 can be made by the user with the touch region 13 to create a touch point. In addition, the sleeve 11 may be rotated so that the scanner 19 can scan the information displayed on the screen 100 and convert the displayed information into digital signals. The microprocessor 211 obtains the digital signals from the scanner 19 via the transmission module 212 and converts the digital signals into the corresponding audio signals. The speaker 15 outputs the corresponding audio signals for the user. Therefore, the user can conveniently obtain an audio of the displayed information; this is particularly advantageous for people with visual impairments.

In other embodiments, the scanner 19 can be positioned in the sleeve 10 adjacent to the touch region 13 so that the scanner 19 can scan the information when the touch region 13 contacts with or approaches the screen 100. In addition, the scanner 19 can scan the information displayed on the screen 100 with a slight position adjustment by rotating the sleeve 11.

The fingertip sleeve 10 coverts the information displayed on the screen 100 to the audio signals so that the user can conveniently obtain an audio of the displayed information. The illustrated embodiment has particular advantages for people with visual impairments.

The exemplary embodiments and their advantages will be understood from the foregoing description, and it will be apparent that various changes may be made thereto without departing from the spirit and scope of the disclosure or sacrificing its material advantages, the examples hereinbefore described merely being preferred or exemplary embodiments of the disclosure.

What is claimed is:

1. A fingertip sleeve used for touching a screen, the fingertip sleeve comprising:
a sleeve comprising a touch region configured to touch the screen;
a scanner configured to scan information displayed on the screen and convert the displayed information into digital signals;
a microprocessor, the microprocessor electronically connected to the scanner and converting the digital signals into audio signals; and
a speaker, the speaker electronically connected to the microprocessor and outputting audio based on the audio signals.

2. The fingertip sleeve of claim 1, further comprising a transmission module electronically connected between the scanner and the microprocessor to transmit the digital signals from the scanner to the microprocessor.

3. The fingertip sleeve of claim 1, further comprising a power supply electronically connected to the scanner and the microprocessor to provide electric power to the scanner and the microprocessor.

4. The fingertip sleeve of claim 1, wherein the sleeve defines an opening to put the sleeve on a fingertip.

5. The fingertip sleeve of claim 1, wherein the sleeve is made of elastic material.

6. The fingertip sleeve of claim 1, wherein the touch region is positioned on an outer surface of the sleeve and protruded from the outer surface.

7. A fingertip sleeve used for touching a screen, the fingertip sleeve comprising:
a sleeve comprising a touch region configured to touch the screen;
a scanner adjacent to the touch region, the scanner scanning information displayed on the screen and converting the displayed information into digital signals upon the touch region approaching the screen;
a microprocessor electronically connected to the scanner and converting the digital signals into audio signals; and
a speaker electronically connected to the microprocessor and outputting audio based on the audio signals.

8. The fingertip sleeve of claim 7, further comprising a transmission module electronically connected between the scanner and the microprocessor to transmit the digital signals from the scanner to the microprocessor.

9. The fingertip sleeve of claim 7, further comprising a power supply electronically connected to the scanner and the microprocessor to provide electric power to the scanner and the microprocessor.

10. The fingertip sleeve of claim 7, wherein the sleeve defines an opening to put the sleeve on a fingertip.

11. The fingertip sleeve of claim 7, wherein the sleeve is made of elastic material.

12. The fingertip sleeve of claim 7, wherein the touch region is positioned on an outer surface of the sleeve and protruded from the outer surface.
